(19) United States
(12) Patent Application Publication
(10) Pub. No.: US 2020/0113281 A1
(43) Pub. Date: Apr. 16, 2020

(54) FLEXIBLE SOLE UNIT

(71) Applicant: The North Face Apparel Corp., Wilmington, DE (US)

(72) Inventors: David Joseph Dirsa, Brentwood, NH (US); Alexander Dardinski, Newburyport, MA (US); Tadd Nicholas Smith, Rye, NH (US)

(21) Appl. No.: 16/598,877

(22) Filed: Oct. 10, 2019

Related U.S. Application Data
(60) Provisional application No. 62/744,819, filed on Oct. 12, 2018.

(51) Int. Cl. A43B 13/18; A43B 13/04; B29D 35/14

(52) U.S. Cl. CPC A43B 13/188; B29D 35/142; A43B 13/04

(57) ABSTRACT

A sole, an article of footwear, and a method of making footwear are described herein. An example sole may comprise a midsole comprising a first region having a first density adapted for providing comfort and a second region having a second density adapted for providing support. The second density may be greater than the first density. The sole may comprise an outsole comprising a plurality of segments selectively disposed adjacent the midsole and adapted for providing traction on a variety of terrains. The outsole may comprise a unitary insert. Each of plurality of segments may be partially isolated from each other by portions of the midsole at least partially surrounding the plurality of segments.

### CROSS-REFERENCE TO RELATED APPLICATIONS

This application is a nonprovisional of and claims the benefit of U.S. Provisional Application No. 62/744,819 filed Oct. 12, 2018, which is hereby incorporated by reference in its entirety.

### BACKGROUND

Conventional footwear includes a sole and upper. A variety of different soles have been proposed, but a typical sole may have features that are not ideal for more strenuous actives. A conventional sole may be overly rigid and be formed as a single piece, making it less adaptable to the terrain. Thus, there is a need for more sophisticated footwear for improved comfort and performance.

### SUMMARY

A sole, an article of footwear, and a method of making footwear are described herein. A sole for an article of footwear may comprise a midsole comprising a first region having a first density adapted for providing comfort and a second region having a second density adapted for providing support. The second density may be greater than the first density. The sole may comprise an outsole comprising a plurality of segments selectively disposed adjacent the midsole and adapted for providing traction on a variety of terrains. The outsole may comprise a unitary insert. Each of plurality of segments may be partially isolated from each other by portions of the midsole at least partially surrounding the plurality of segments.

An example article of footwear may comprise an upper configured to at least partially enclose a foot. The article may comprise a sole coupled to the upper. The sole may comprise a midsole comprising a first region having a first density adapted for providing comfort and a second region having a second density adapted for providing support. The second density may be greater than the first density. The sole may comprise an outsole comprising a plurality of segments selectively disposed adjacent the midsole and adapted for providing traction on a variety of terrains. The outsole may comprise a unitary insert. Each of plurality of segments may be partially isolated from each other by portions of the midsole at least partially surrounding the plurality of segments.

An example method of making footwear may comprise forming a midsole comprising a first region having a first density adapted for providing comfort and a second region having a second density adapted for providing support. The second density may be greater than the first density. The method may comprise forming an outsole comprising a plurality of segments adapted for providing traction on a variety of terrains. The outsole may comprise a unitary insert. The method may comprise coupling the outsole to the midsole. Each of plurality of segments may be partially isolated from each other by portions of the midsole at least partially surrounding the plurality of segments.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an exploded view of an example sole for an article of footwear.

FIG. 2 shows a bottom up view of an outsole and a midsole.

FIG. 3 shows a perspective view of a sole combining the outsole and midsole.

FIG. 4 shows another view of the sole with an exposed cross-section of the sole.

FIG. 5 shows a side view of an example assembled sole.

FIG. 6 shows a cross-sectional side view of an assembled sole.

FIG. 7 is a flowchart showing an example method of making the example sole.

### DETAILED DESCRIPTION OF ILLUSTRATIVE EMBODIMENTS

A sole, an article of footwear, and a method of making footwear are described herein. The sole and article of footwear of the present disclosure use segmentation in one or both of the outsole and the midsole. The resulting sole is more adaptable to difficult terrain and more lightweight. The sole and article of footwear may also have use multiple regions of varied density to optimize comfort on the inner portion of shoe and optimize support on the outer portion of the shoe.

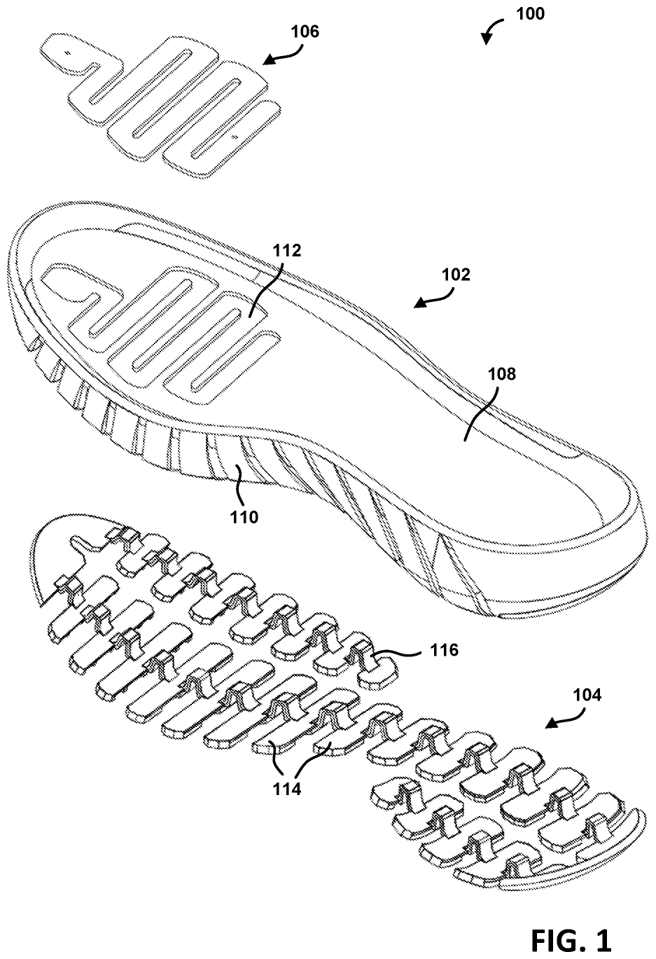

FIG. 1 shows an exploded view of an example sole 100 for an article of footwear. The sole 100 may comprise a midsole 102. The sole 100 may comprise an outsole 104. The sole 100 may comprise a plate 106. The midsole 102, the outsole 104, and/or the plate 106 may be coupled together to form the sole 100. The sole 100 may be coupled together with an upper, not shown, to form the completed article of footwear. The article of footwear may comprise active wear, such as a sports shoe, athletic shoe, tennis shoe, running shoe, trail running shoe, and/or the like. The segmentation of the midsole 102 and/or the outsole 104 allow the sole 100 to adapt to any terrain and increase ground contact.

The midsole 102 may be optimized for comfort and support. The midsole 102 may have a variable density throughout the midsole 102. Softer regions of the midsole 102 may provide comfort and more rigid regions may provide support. The midsole 102 may be flexible for adaptability to a variety of terrains. The midsole 102 may comprise first region 108. The first region 108 may comprise an inner core of the midsole 102. The first region 108 may comprise a top side disposed towards an inside of the footwear. The first region 108 may be disposed to directly contact a foot of a wearer of the footwear. The first region 108 may be contoured and/or shaped to match a shape of the foot.

The first region 108 may have a first density. The first density may be adapted for providing comfort. The first region 108 may have a first material. The first material may be adapted for providing comfort. The first region 108 may comprise a soft and/or flexible material. The first material may comprise a first foam. The first foam may comprise a soft foam, a low density foam, and/or the like. For example, the first foam may comprise about a 50 C foam.

The midsole 102 may comprise a second region 110. The second region 110 may be adapted for providing support, protection, and/or the like. The second region 110 may comprise a bottom side disposed towards and exterior of the footwear. The second region 110 may be disposed to be at least partially in contact with the ground. The second region 110 may a second material. The second material comprise a rigid material (e.g., for providing support), a durable material, and/or the like. The second region 110 may have a shape that supports and/or conforms to a shape of a foot of a wearer. The second region 110 may have a second density. The second density may be adapted for providing support. The second region 110 may comprise a second foam. The second foam may be a moderate and/or high density foam. As an example, the second foam may comprise about a 60 asker C foam. An EVA foam may be used, but other materials may be used such as TPU, TPE, and PU foams.

As an example, at least a sample of the first region exhibits between 35-55 C and at least a sample of the second region exhibits between 55 C-65 C when measured using an ASKER Durometer. As a further example, a difference in hardness between at least a sample of the first region and at least a sample of the second region is between 7 and 15 C when measured using an ASKER Durometer.

As an example, at least a sample of the first region exhibits between 35-55 C and at least a sample of the second region exhibits between 55 C-65 C when measured using an ASKER C type Durometer. As a further example, a difference in hardness between at least a sample of the first region and at least a sample of the second region is between 7 and 15 C when measured using an ASKER C type Durometer.

As an example, at least a sample of the first region exhibits between 35-55 C and at least a sample of the second region exhibits between 55 C-65 C when measured in accordance with JIS K 7312. As a further example, a difference in hardness between at least a sample of the first region and at least a sample of the second region is between 7 and 15 C when measured in accordance with JIS K 7312.

As an example, at least a sample of the first region exhibits between 35-55 C and at least a sample of the second region exhibits between 55 C-65 C when measured in accordance with JIS S 6050. As a further example, a difference in hardness between at least a sample of the first region and at least a sample of the second region is between 7 and 15 C when measured in accordance with JIS S 6050.

The second density may be greater than the first density. It should be understood that the first density and/or the second density may not be uniform. The first density and/or second density may vary in different portions of the midsole 102. The first density and/or second density may vary during usage of the footwear (e.g., due to impact from the foot and/or ground). The first density and/or the second density may be average densities (e.g., over time, over space). Reference to one density being greater than another may be evaluated as an expected density, an average density, a density in a resting state, a density in similar conditions, and/or the like.

The first region 108 and the second region 110 may be coupled together via a co-molding process, pressing process, gluing process, melting process, and/or the like. The first region 108 and the second region 110 may be seamlessly coupled together (e.g., via bonding). The second region 110 may partially surround the first region 108. The second region 110 may partially surround the first region 108 along a bottom side of the first region 108. The second region 110 may comprise at least a partial perimeter of the midsole 102. The second region 110 may partially surround the first region 108 along a perimeter of the first region 108. Both the first region 108 and the second region 110 may extend along the length of the midsole 102 from the forefoot to the heel. The second region 110 may extend further along the length of the midsole 102 into the forefoot of the midsole 102. The portion that extends further than the first region 108 may be the perimeter. The first region 108 may extend further along the length of the midsole 102 than the second region 110 into the heel of the midsole 102. The top side of the first region 108 may be exposed without being surrounded by the second region 110. A bottom side of the first region 108 may be coupled to and/or surrounded by (e.g., adjacent to, enclosed by) the second region 110. In some implementations, the first region 108 may comprise a heel portion of the midsole 102. The heel portion of the first region 108 may be exposed without being surrounded by the second region 110. The heel portion of the first region 108 may be configured as a heel crash pad. The soft material of the first region 108 maybe exposed in the heel area to soften the heel strike (e.g., especially during the decent). In other implementations, the second region 110 may comprise the heel portion of the midsole 102.

The plate 106 may be adapted to form a protective barrier in the midsole 102. The plate 106 may be disposed in a matching opening 112 of the first region 108. The plate 106 may be adapted to block sharp objects from reaching the foot. The plate 106 may be any shape, such as a solid shape, a winding shape, a zig-zag, and/or the like. The plate 106 may be disposed adjacent to a forefoot region of the midsole 102. The plate 106 may be coupled to a forefoot region of the midsole 102. The plate 106 may comprise a protective material that does not detract from flexibility. The plate 106 may comprise a flexible material. The plate 106 may comprise a third density that may be greater than the first density and the second density. As an example, the plate 106 may comprise a 70C material, such as 70C plastic, foam, and/or the like. As an example, the plate 106 may be configured to allow or maintain the flexibility of the sole-unit, while still offering protection from the terrain and eliminate the “feel-through” of sharp object. As a further example, the plate is a 70 asker C raw EVA plastic film (without any blowing agents) that is co-molded with the EVA foam. However, other materials may be used.

As a further explanation of the outsole 104, the outsole 104 may be adapted for providing traction, such as a high traction (e.g., higher than conventional rubber) for a trail running footwear. Segmentation of the outsole 104 may configure the outsole 104 to adapt to different terrain and increase ground contact. The outsole 104 may comprise a plurality of segments 114. The plurality of segments 114 may be adapted for providing traction on a variety of terrains. The plurality of segments 114 may coupled together as one or multiple regions of the outsole 104. The outsole 104 may comprise a unitary insert (e.g., with all segments 114 coupled to form the unitary insert). The plurality of segments 114 may be separated.

The plurality of segments 114 may be selectively disposed adjacent (e.g., or at least partially in) the midsole 102. The segments 114 may be selected to match a design specification of the footwear. Different patterns may be selected for different design specifications. For example, a different pattern of the plurality of segments 114 may be used for trail running footwear than a pattern used for hiking footwear or conventional running shoes.

Each of plurality of segments 114 may be partially isolated from each other by portions of the midsole 102 at least partially surrounding the plurality of segments 114. The plurality of segments 114 may comprise a material having an adhesive quality for increased traction. For example, the plurality of segments 114 (e.g., the outsole 104) may comprise rubber (e.g., 55-65 Shore A rubber).

One or more of plurality of segments 114 may be coupled (e.g., connected) together via a plurality of couplings 116 (e.g., runners, lines, links). A coupling 116 may extend between two segments. A coupling 116 may extend upward into the midsole 102. A coupling 116 may be configured to function (e.g., act) as a spring (e.g., or mechanically resistive element) between the plurality of segments 114. For example, two vertical members (e.g., extending up into the midsole 102) may be attached via a horizontal member (e.g., that runs along the width of a vent). The horizontal member may bend and/or compress in response to force from the vertical members. The horizontal member may exert a force in return to resist the compression and/or bending of the horizontal member. The couplings 116 may comprise the same material as the plurality of segments 114, such as rubber.

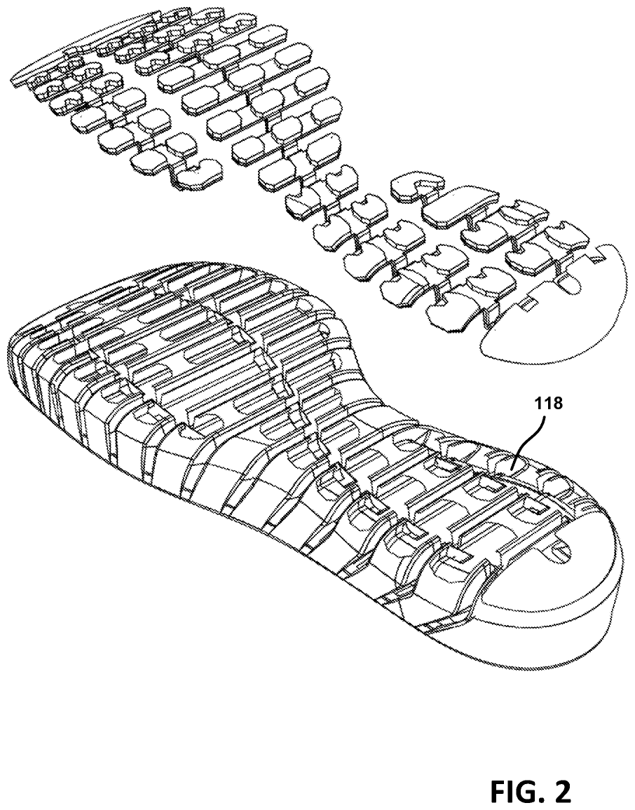

FIG. 2 shows a bottom up view of the outsole 104 and the midsole 102. The midsole 102 may comprise a plurality of openings 118 (e.g., holes). The plurality of openings 118 may be in a bottom side of the midsole 102. The plurality of openings 118 may be formed using a mold when the midsole 102 (e.g., or second region 110) is formed. The plurality of openings 118 may match a shape, size, depth, pattern, and/or the like of the plurality of segments 114 of the outsole 104. The plurality of openings 118 may allow the outsole 104 to be disposed (e.g., or embedded) at least partially in midsole 102 (e.g., or second region 110 of the midsole 102).

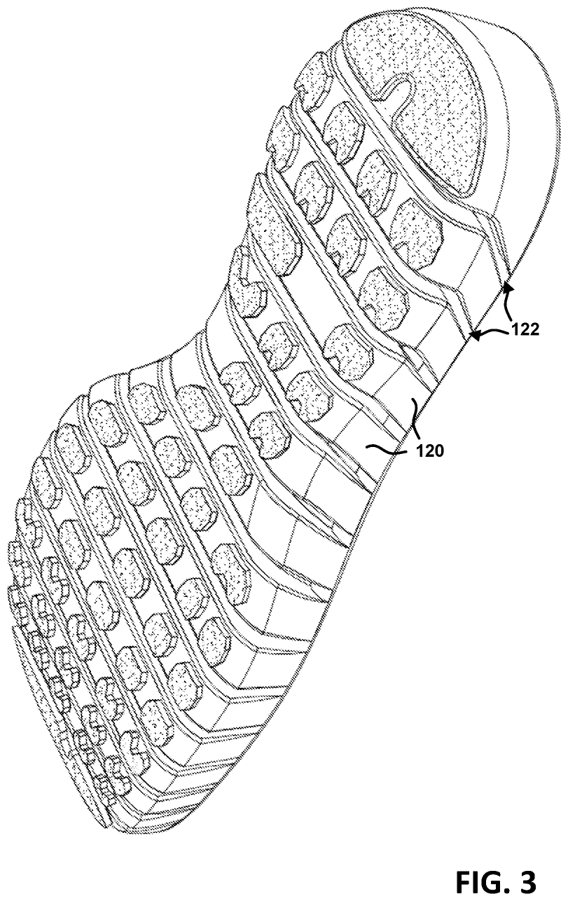

FIG. 3 shows a perspective view of a sole 100 comprising the outsole 104 and midsole 102. The plurality of segments 114 are shown selectively disposed in the midsole 102. The plurality of segments 114 may be disposed adjacent (e.g., or in) a plurality of ridges 120 of the second region 110 of the midsole 102. The plurality of ridges 120 may extend laterally (e.g., along the width) from one side of the midsole 102 to the other side. The plurality of ridges 120 may be separated by vents 122 (e.g., or gaps). The vents 122 may expose the first region 108 of the midsole 102. Each of the plurality of segments 114 may comprise an extrusion (e.g., stud, lug). An extrusion may at least partially extrude from the midsole 102. The plurality of vents 122 (e.g., or gaps) may extend from a left side to a right side of the second region 110 (e.g., or midsole 102) along a bottom side of the second region 110 (e.g., or midsole 102) in a lateral direction.

The plurality of segments 114 may be disposed (e.g., place, organized) as a plurality of sections. A section may be disposed on a ridge 120. The sections may laterally extend along a width of the sole 100. The sections may be separated by one or more of the vents 122. For example, each ridge 120 may comprise a section. The plurality of sections may have a variety of sizes (e.g., area, number of segments). A section may comprise any number of segments 114. For example, a section in a heel portion of the sole 100 may comprise from about 1 to about 4 segments 114. A section in a forefoot portion of the sole 100 may comprise from about 4 to about 8 segments 114.

The plurality of segments 114 may have a variety of shapes and sizes. The plurality of segments 114 may comprise a first group of segments 114 in a forefoot region and/or toe region. The plurality of segments 114 may comprise a second group of segments 114 in a heel region. The plurality of segments 114 may comprise a third group of segments 114 in a midfoot region between the forefoot region and the heel region. The first group, the second group, and the third group have corresponding size and shape characteristics.

The segments 114 of the first group that are near a toe region may be adapted for grabbing and/or traction (e.g., to increase toe-off while ascending). The segments 114 of the first group near the toe area may be directional. The segments 114 of the first group near the toe area may have a notch on one side (e.g., the side towards the back of the midsole 102). Segments 114 of the first group that are near a forefoot area (e.g., between the mid-foot and toe area) may be adapted to be omni-directional. Segments 114 of the first group near the forefoot area may not have any notches. Segments 114 of the first group near the forefoot may be adapted to provide penetration into loose surface material (e.g., on the trail).

The segments 114 in the second group may be adapted for breaking and/or enduring higher wear than the other groups. The segments 114 in the second group may have a notch (e.g., or groove). The notch may be on a side towards the front of the midsole 102. The segments 114 in the second group may have more mass (e.g., more size, greater height) than segments 114 in the other groups.

The segments 114 in the third group may be adapted for breaking in multiple directions. The segments 114 in the third group may have notches on both the front side and the back side of the segments 114. The segments 114 in the second group may be disposed along a center line of pressure of the running gate.

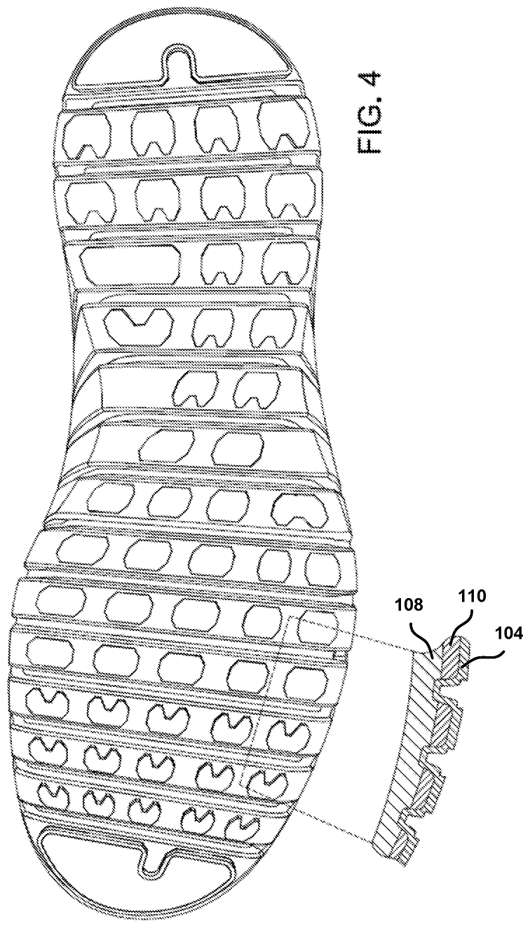

FIG. 4 shows another view of the sole 100 with exposed cross-section of the sole 100. The cross-section shows a manner in which the outsole 104 may be disposed on the midsole 102. The outsole 104 may be disposed within gaps (e.g., or vents 122) between ridges 120 of the second region 110 of the midsole 102. The outsole 104 may be disposed adjacent to the second region 110 of the midsole 102. The outsole 104 may cover the bottom edge and/or side edges of the ridges 120. The outsole 104 may also be disposed adjacent the first region 108 of the midsole 102. The outsole 104 may be disposed adjacent to regions of the first region 108 that are exposed by the gaps.

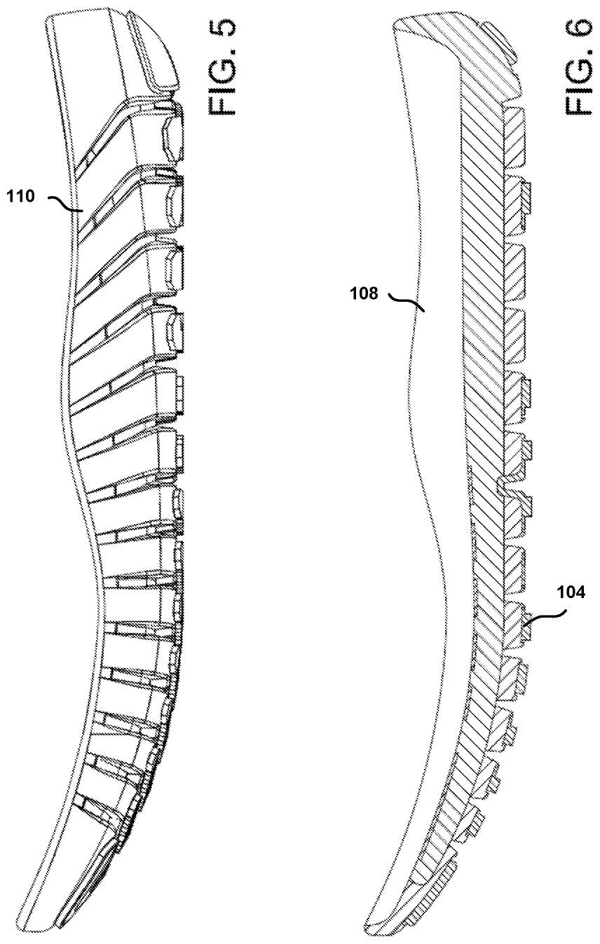

FIG. 5 shows a side view of an example assembled sole 100. An exterior of the midsole 102 and outer sole are shown. As explained further herein, the vents 122 of the midsole 102 may extend up the side of the sole 100. This feature may allow for venting as well as flexibility and adaptability of the sole 100 upon terrain. FIG. 6 shows a cross-sectional side view of an assembled sole 100. The first region 108 of the midsole 102 is shown. As explained further herein, the first region 108 may comprise a heel portion. The first region 108 may comprise an interior wall in the heel portion of the midsole 102. This feature may allow for great cushioning for the heel of a wearer.

The present disclosure comprise at least the following aspects:

Aspect 1. A sole for an article of footwear comprising: a midsole comprising a first region having a first density adapted for providing comfort and a second region having a second density adapted for providing support, wherein the second density is greater than the first density; and an outsole comprising a plurality of segments selectively disposed adjacent the midsole and adapted for providing traction on a variety of terrains, wherein the outsole comprises a unitary insert, and wherein each of plurality of segments are partially isolated from each other by portions of the midsole at least partially surrounding the plurality of segments.

Aspect 2: A sole for an article of footwear comprising: a midsole comprising a first region configured for comfort and a second region configured for support, wherein the second region manages shear forces exhibited in or on the midsole and at least partially guides a foot of a wearer toward the first region; and an outsole comprising a plurality of segments selectively disposed adjacent the midsole and configured for providing traction on a variety of terrains, wherein the outsole comprises a unitary insert, and wherein each of plurality of segments are partially isolated from each other by portions of the midsole at least partially surrounding the plurality of segments.

Aspect 3: The sole of any one of aspects 1-2, wherein at least a sample of the first region exhibits between 35-55 C and at least a sample of the second region exhibits between 55 C-65 C when measured using an ASKER Durometer, or wherein a difference in hardness between at least a sample of the first region and at least a sample of the second region is between 7 and 15 C when measured using an ASKER Durometer.

Aspect 4: The sole of any one of aspects 1-2, wherein at least a sample of the first region exhibits between 35-55 C and at least a sample of the second region exhibits between 55 C-65 C when measured using an ASKER C type Durometer, or wherein a difference in hardness between at least a sample of the first region and at least a sample of the second region is between 7 and 15 C when measured using an ASKER C type Durometer.

Aspect 5: The sole of any one of aspects 1-2, wherein at least a sample of the first region exhibits between 35-55 C and at least a sample of the second region exhibits between 55 C-65 C when measured in accordance with JIS K 7312, or wherein a difference in hardness between at least a sample of the first region and at least a sample of the second region is between 7 and 15 C when measured in accordance with JIS K 7312.

Aspect 6: The sole of any one of aspects 1-2, wherein at least a sample of the first region exhibits between 35-55 C and at least a sample of the second region exhibits between 55 C-65 C when measured in accordance with JIS S 6050, or wherein a difference in hardness between at least a sample of the first region and at least a sample of the second region is between 7 and 15 C when measured in accordance with JIS S 6050.

Aspect 7: The sole of any one of aspects 1-6, wherein the first region comprises a first foam and the second region comprises a second foam, and wherein the outsole comprises rubber.

Aspect 8: The sole of any of aspects 1-7, wherein the second region partially surrounds the first region along a bottom side and a perimeter of the first region, and wherein a heel portion and a top portion of the first region is exposed without being surrounded by the second region.

Aspect 9: The sole of any of aspects 1-8, wherein the plurality of segments comprise a first group of segments in a forefoot region, a second group of segments in a heel region, and a third group of segments in a midfoot region between the forefoot region and the heel region, wherein the first group, the second group, and the third group have corresponding size and shape characteristics.

Aspect 10: The sole of any of aspects 1-9, wherein the plurality of segments are connected via a plurality of couplings extending upward into the midsole and acting as springs between the plurality of segments.

Aspect 11: The sole of any of aspects 1-10, wherein the second region comprises a plurality of vents that extend from a left side to a right side of the midsole along a bottom side of the midsole in a lateral direction.

Aspect 12: The sole of any of aspects 1-11, wherein a portion of the midsole is interposed between two or more of the plurality of segments.

Aspect 13: The sole of any of aspects 1-12, further comprising a plate disposed in or coupled to a forefoot region of the midsole, wherein the plate has a third density that is greater than the first density and the second density.

Aspect 14: An article of footwear comprising: an upper configured to at least partially enclose a foot; and a sole coupled to the upper, wherein the sole comprises: a midsole comprising a first region having a first density adapted for providing comfort and a second region having a second density adapted for providing support, wherein the second density is greater than the first density; and an outsole comprising a plurality of segments selectively disposed adjacent the midsole and adapted for providing traction on a variety of terrains, wherein the outsole comprises a unitary insert, and wherein each of plurality of segments are partially isolated from each other by portions of the midsole at least partially surrounding the plurality of segments.

Aspect 15: The article of aspect 14, wherein the first region comprises a first foam and the second region comprises a second foam, and wherein the outsole comprises rubber.

Aspect 16: The article of any of aspects 14-15, wherein the second region partially surrounds the first region along a bottom side and a perimeter of the first region, and wherein a heel portion and a top portion of the first region is exposed without being surrounded by the second region.

Aspect 17: The article of any of aspects 14-16, wherein the plurality of segments comprise a first group of segments in a forefoot region, a second group of segments in a heel region, and a third group of segments in a midfoot region between the forefoot region and the heel region, wherein the first group, the second group, and the third group have corresponding size and shape characteristics.

Aspect 18: The article of any of aspects 14-17, wherein the plurality of segments are connected via a plurality of runner extending upward into the midsole and acting as springs between the plurality of segments.

Aspect 19: The article of any of aspects 14-18, wherein the second region comprises a plurality of vents that extend from a left side to a right side of the midsole along a bottom side of the midsole in a lateral direction.

Aspect 20: The article of aspect 19, wherein the plurality of segments comprise a plurality of laterally extending sections disposed between the plurality of vents.

Aspect 21: The article of any of aspects 14-20, further comprising a plate disposed in or coupled to a forefoot region of the midsole, wherein the plate has a third density that is greater than the first density and the second density.

Aspect 22: A method of making footwear comprising: forming a midsole comprising a first region having a first density adapted for providing comfort and a second region having a second density adapted for providing support, wherein the second density is greater than the first density; forming an outsole comprising a plurality of segments adapted for providing traction on a variety of terrains, wherein the outsole comprises a unitary insert; and coupling the outsole to the midsole, wherein each of plurality of segments are partially isolated from each other by portions of the midsole at least partially surrounding the plurality of segments.

Aspect 23: The method of aspect 22, wherein the coupling the outsole to the midsole comprises performing a co-molding process.

Aspect 24: The method of any of aspects 22-23, wherein the first region comprises a first foam and the second region comprises a second foam, and wherein the outsole comprises rubber.

Aspect 25: The method of any of aspects 22-24, wherein the second region partially surrounds the first region along a bottom side and a perimeter of the first region, and wherein a heel portion and a top portion of the first region is exposed without being surrounded by the second region.

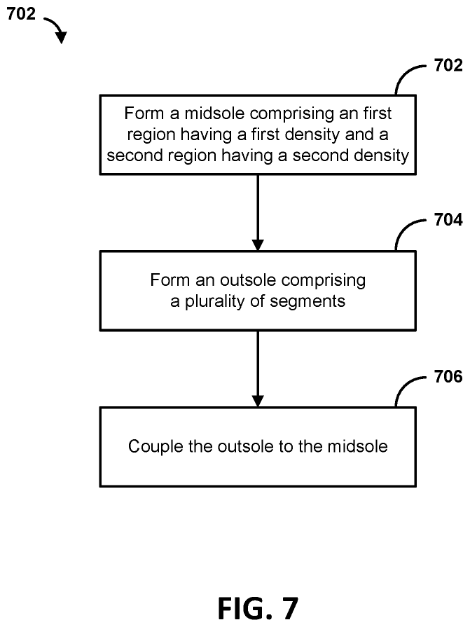

FIG. 7 is a flowchart showing an example method of making the example sole. At step 702, a midsole may be formed. The midsole may comprise a first region. The first region may have a first density. The first region and/or first density may be adapted for providing comfort. The midsole may comprise a second region. The second region may have a second density. The second region and/or second density may be adapted for providing support. The second density may be greater than the first density. The first region may comprise a first foam. The second region may comprise a second foam. The outsole may comprise rubber.

The second region may partially surround the first region. The second region may partially surround the first region along a bottom side and/or a perimeter of the first region. A heel portion and/or a top portion of the first region may be exposed without being surrounded by the second region.

At step 704, an outsole may be formed. The outsole may comprise a plurality of segments. The plurality of segments may be adapted for providing traction on a variety of terrains. The outsole may comprise a unitary insert.

At step 706, the outsole may be coupled to the midsole. One or more (or each) of plurality of segments may be partially isolated from each other by portions of the midsole at least partially surrounding the plurality of segments.

The coupling of the outsole to the midsole may comprise performing a co-molding process. The co-molding process may have an improved bonding strength (e.g., preventing delamination). The co-molding process may enable a thinner than conventional base thickness for the plurality of segments. The co-molding process may decrease weight and improve flexibility. Couplings (e.g., runners, links) that couple the segments together (e.g., as one unitary insert) may facilitate inserting the outsole into the mold during the co-molding process. As an example, the couplings or links may be configured to be flexible and act like springs between the ground contacting segments.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A sole for an article of footwear comprising:
a midsole comprising a first region having a first density adapted for providing comfort and a second region having a second density adapted for providing support, wherein the second density is greater than the first density; and
an outsole comprising a plurality of segments selectively disposed adjacent the midsole and adapted for providing traction on a variety of terrains, wherein the outsole comprises an insert, and wherein two or more of the plurality of segments are at least partially isolated from each other by portions of the midsole at least partially surrounding the plurality of segments.

2. The sole of claim 1, wherein at least a sample of the first region exhibits between 35-55 C and at least a sample of the second region exhibits between 55 C-65 C when measured using an ASKER Durometer, or wherein a difference in hardness between at least a sample of the first region and at least a sample of the second region is between 7 and 15 C when measured using an ASKER Durometer.

3. The sole of claim 1, wherein at least a sample of the first region exhibits between 35-55 C and at least a sample of the second region exhibits between 55 C-65 C when measured using an ASKER C type Durometer, or wherein a difference in hardness between at least a sample of the first region and at least a sample of the second region is between 7 and 15 C when measured using an ASKER C type Durometer.

4. The sole of claim 1, wherein at least a sample of the first region exhibits between 35-55 C and at least a sample of the second region exhibits between 55 C-65 C when measured in accordance with JIS K 7312, or wherein a difference in hardness between at least a sample of the first region and at least a sample of the second region is between 7 and 15 C when measured in accordance with JIS K 7312.

5. The sole of claim 1, wherein at least a sample of the first region exhibits between 35-55 C and at least a sample of the second region exhibits between 55 C-65 C when measured in accordance with JIS S 6050, or wherein a difference in hardness between at least a sample of the first region and at least a sample of the second region is between 7 and 15 C when measured in accordance with JIS S 6050.

6. The sole of claim 1, wherein the first region comprises a first foam and the second region comprises a second foam, and wherein the outsole comprises rubber.

7. The sole of claim 1, wherein the second region comprises a plurality of vents that extend from a left side to a right side of the midsole along a bottom side of the midsole in a lateral direction.

8. The sole of claim 1, wherein a portion of the midsole is interposed between two or more of the plurality of segments.

9. The sole of claim 1, further comprising a plate disposed in or coupled to a forefoot region of the midsole, wherein the plate has a third density that is greater than the first density and the second density.

10. A sole for an article of footwear comprising:
a midsole comprising a first region configured for comfort and a second region configured for support, wherein the second region manages shear forces exhibited in or on the midsole and at least partially guides a foot of a wearer toward the first region; and
an outsole comprising a plurality of segments selectively disposed adjacent the midsole and configured for providing traction on a variety of terrains, wherein the outsole comprises a unitary insert, and wherein each of plurality of segments are at least partially isolated from each other by portions of the midsole at least partially surrounding the plurality of segments.

11. The sole of claim 10, wherein at least a sample of the first region exhibits between 35-55 C and at least a sample of the second region exhibits between 55 C-65 C when measured using an ASKER Durometer, or wherein a difference in hardness between at least a sample of the first region and at least a sample of the second region is between 7 and 15 C when measured using an ASKER Durometer.

12. The sole of claim 10, wherein at least a sample of the first region exhibits between 35-55 C and at least a sample of the second region exhibits between 55 C-65 C when measured using an ASKER C type Durometer, or wherein a difference in hardness between at least a sample of the first region and at least a sample of the second region is between 7 and 15 C when measured using an ASKER C type Durometer.

13. The sole of claim 10, wherein at least a sample of the first region exhibits between 35-55 C and at least a sample of the second region exhibits between 55 C-65 C when measured in accordance with JIS K 7312, or wherein a difference in hardness between at least a sample of the first region and at least a sample of the second region is between 7 and 15 C when measured in accordance with JIS K 7312.

14. The sole of claim 10, wherein at least a sample of the first region exhibits between 35-55 C and at least a sample of the second region exhibits between 55 C-65 C when measured in accordance with JIS S 6050, or wherein a difference in hardness between at least a sample of the first region and at least a sample of the second region is between 7 and 15 C when measured in accordance with JIS S 6050.

15. The sole of claim 10, wherein the second region comprises a plurality of vents that extend from a left side to a right side of the midsole along a bottom side of the midsole in a lateral direction.

16. The sole of claim 10, further comprising a plate disposed in or coupled to a forefoot region of the midsole, wherein the plate has a third density that is greater than the first density and the second density.

17. An article of footwear comprising the sole of claim 1.

18. An article of footwear comprising the sole of claim 10.

19. A method of making the sole of claim 1.

20. A method of making the sole of claim 10.
